(19) United States
(12) Patent Application Publication
(10) Pub. No.: US 2002/0025094 A1
(43) Pub. Date: Feb. 28, 2002

(54) Support disk for a support disk bearing for spin rotors

(76) Inventors: Edmund Schuller, Ingolstadt (DE); Mantred Knabel, Ingolstadt (DE)

Correspondence Address: STEPHEN E. BONDURA, ESQ., DORITY & MANNING, P.A., P.O. Box 1449, Greenville, SC, 29602, US

(21) Appl. No.: 09/833,086

(22) Filed: Apr. 11, 2001

(30) Foreign Application Priority Data
Apr. 13, 2000 (DE) 100 18 440.5

(51) Int. Cl. F16C 13/00

(52) U.S. Cl. 384/549

(57) ABSTRACT

Proposed is a support disk for a support disk bearing for a open-end spin rotor, which support disk possesses a body (5), which, on its circumferential surface is designed to receive a cover layer (143) The cover layer 143 is comprised of rubber, this being in particular nitrile rubber (NBR). In an advantageously favorable formulation, the cover layer (143) contains an additive for the reduction of its electrical resistance.

The present invention concerns a support disk for a support disk bearing for an open-end spin rotor in accord with the generic concept of claim 1.

Generic conventional support disks have been disclosed by DE 33 24 129 A1 describing a bearing for spin rotors. The support disks comprise a body, which, for instance, is constructed of plastic or metal and which, on its circumference possesses a plastic ring which forms the running surface for the rotor shaft which it bears. The plastic ring, in this case, is applied by spraying on to the body. In the present state of the technology, the material used on the circumference of the disk with the plastic ring and which is driven by the said shaft, is polyurethane polymer.

This elastic plastic ring, which forms the running surface of the rotor shaft, has the characteristic, that it possesses damping qualities, so that oscillations may be damped during a vibratory period in the run of the spin rotor, which can occur for instance, by imbalance or through impacts of the driving tangential belts,. With the known support disk bearings and support disks equipped with said circumferential surfacings made of polyurethane, rotational speeds of the rotor shaft of up to 110,00 RPM are possible.

Besides the mentioned advantages, the circumferential polyurethane covering of the support disk also has the drawback of excessive wear. Because of the continual deformation, i.e. compression and expansion of the running surface, this component is heated to such a degree, that complete destruction of the layer occurs. In order to repress this behavior of the support disk, within the state of the technology it is a conventional practice to place a cooling groove in this outer layer. This is made known by U.S. Pat. No. 5,178,473.

Along with this, the known support disks are deficient in that the polyurethane running surface separates itself from the base part of the support disk, whereby destruction of the said support disk follows.

In order to avoid problems of this nature, it is a known practice in the state of the technology, that for such support disks, as have the plastic cover layer applied onto the body, a form fit connection be provided between, as seen in a radial direction of the support disk, the body and the plastic cover layer. A support disk of this kind is described in DE 42 27 489 A1. From DE 198 24 286 A1, a support disk has been made known, which is provided with, besides a cooling groove, also a cleaning groove, as well as further measures so that during an operational run of the rotor spin apparatus, contamination is prevented on the rotor shaft, which would cause additional maintenance.

Experience has shown, that the support disks of the state of the technology exhibit faults when installed, and in spite of the known measures, have only a very restricted operational life, which limits their employment in modern rotor spinning machines. The stresses thereby brought about lead to an early failure of the support disks, so that besides the high expenditures for the necessary replacement parts, the productivity of the spinning machine is lessened because of the required maintenance work.

Thus the purpose of the present invention is, to eliminate the disadvantages of the state of the technology, and to make available support disks, which provide bearings suitable for open-end spin rotors even at the most extreme speeds of rotation, without the detriment of an insufficient length of operational life.

This purpose of the present invention is achieved through the a support disk in accord with claim 1.

By means of the formulation of the support disk in accord with the invention, it is advantageously attained, that between the body and the running surface of the support disk, a secure connection is created. This connection resists such forces as are incurred by said in-and-out flexing, even at the highest speeds of rotation and loadings. The loosening of the applied circumferential layer from the body of the disk does not occur.

Furthermore, the support disk, constructed in accord with the invention, possesses very good rolling characteristics for the carried rotor shaft. In this way also, an unsteady phase in the running behavior of the rotor is substantially ameliorated by the excellent damping properties of the support disk, and vibrations are damped.

The damping operation in the circumferential cover layer of the support disk, advantageously, can be carried out by the said layer, without detriment to the quality of the running surface. In particular, the most favorable damping characteristics of the invented cover layer for the running surface of the support disk in accord with the invention, makes it possible to hold the thickness of the cover layer of the support disk to a minimum. This has the additional virtue in that the heat removal from the said cover layer is alleviated. The flexing brought about in the cover layer, on this account, does not lead to excessive heating of the cover layer. This advantage substantially increases the operational life of the cover layer as well as that of the support disk.

In an advantageous development of the invention, the cover layer of the support disk is furnished with a cooling groove for even better dissipation of heat from the cover layer during operation. This further increases the wear resistance of the support disk.

Providing a design of the body with circumferential profiling in a radial direction, is a favorable design to bring about a form fit connection between the body and the cover layer. Even when this may not seem necessary, due to a current application, such profiling does enable future higher load demands to be met by the support disk.

By the design of the cover layer with a cleaning groove for the suppression of contaminant deposits on the rotor shaft, disturbances in operation are reduced. Such deposits are also hindered by the fact that the cover layer of the support disk has a low electrical resistance, advantageously less than 1.0×10⁹ Ohm. In order to achieve this, advantageously, the rubber material is treated with an additive for the increase of its electrical conductivity.

In an advantageous development of the invention, the cover layer on the support disk consists of nitrile rubber ([acrylo] nitrile-butadiene rubber), hereinafter, “NBR”.

This material has especially favorable mechanical characteristics, which cause it to be practically abrasion proof in rough operational conditions. Even better advantageous properties are possesses by the rubber H-NBR.

This rubber can contain additives, so that it requires no special aging, which is required, for instance, of the polyurethane used in practice in accord with the state of the technology. NBR or HNBR, as a result of these additives, has the characteristics of an already aged material and thus, from the beginning, possesses uniform, unchanging properties.

Fortunately, there is found in an advantageous development of the invention, a rubber with a tensile strength to meet at least 28 N/mm². Advantageously, a rubber is available for use with a Shore Hardness of A 85 to 105. Thereby, favorable damping values can be achieved for the cover layer. Just as advantageous is a rubber with a hardness between Shore D 45 to 70. The use of a rubber for the support disk with an elasticity of at lest 29% assures a high resistance to wear and good damping.

If the support disk has, on the circumference of the cover layer, one or more grooves, then, in an advantageous manner, the support disk cover layer can endure even the highest loadings. The groove can fulfill several purposes. For example, the groove can be used for cooling the cover layer or for the cleaning of the shaft of the open spin rotor. Moreover, by means of the installation of the grooves, the rolling contact friction of the shafts against the support disks is lessened.

If the grooves penetrate to the body of the support disk, that is, if the cover layer is essentially made of a plurality of individual, elements, independent of one another, then a highly satisfactory cooling of the cover layer and the support disk is assured. The holding qualities of the rubber of the cover layer onto the body of the support disks, especially when this is made of aluminum, are particularly good. Thus it is possible to fasten the cover layer without lateral restraint directly to the body on the circumferential surface. However, for certain manufacturing technical reasons certain small lateral restraint may be necessary. The scuffing off of the cover layer from the support disks is not to be feared with the invented formulation of the cover layer within foreseeable loadings.

If the cover layer has a thickness of less than 4 mm or if it is less than 1.9 times the depth of the deepest groove, then the cover layer possesses an especially good relationship of the cover layer in reference to its structural strength and the cooling and cleaning effects of the groove.

Respectively, in accord with each instance, it can be of advantage, if one or more cleaning grooves are placed on the cover layer of the support disk.

If the body has been surface treated, especially if the body is of aluminum and has been anodized, then other advantages appear. By means of the surface treatment, damage to the material of the body, particularly by oxidation, is prevented. Besides this, by means of the surface treatment, characterizing colorations are possible, so that the installation of different support disks can be chromatically designated in a simple way and thus unwanted exchange can be avoided. By means of the special characteristics of the material of the invented cover layer of the support disks, it is even possible, that an anodized surface can be put in place after the installation of the circumferential cover layer. By means of the anodized surfacing, that is, the anodizing of the support disk with the cover layer in place, the said circumferential cover layer is not affected and its action is not impaired. The anodizing can take place after the finishing work of the support disk.

Invented support disks with outside diameters between 50 and 80 mm have performed exceptionally well for installation in the support bearing system for spin rotors.

The contact surface between cover layer and rotor shaft shows a width of between 4 and 12 mm. This is sufficient, in order, first, to see that a predominantly slip-free rolling contact of the rotor shaft on the support disk is actuated, and second, the rolling resistance is held to the least possible amount.

For a minimum width of the cover layer, a value of some 2 mm is seen as particularly to be recommended. At this width, it is even possible to work out a direct fastening of the cover layer on the circumference of the body without lateral restraint between the body and the cover layer. When the body is of aluminum, a particularly sufficient hold between the invented cover layer and the circumference is obtained.

Beyond this, the 2 mm is enough to avoid a lateral kinking of the cover layer.

In the following the invention will be described with the aid of illustrative presentations. There is shown in:

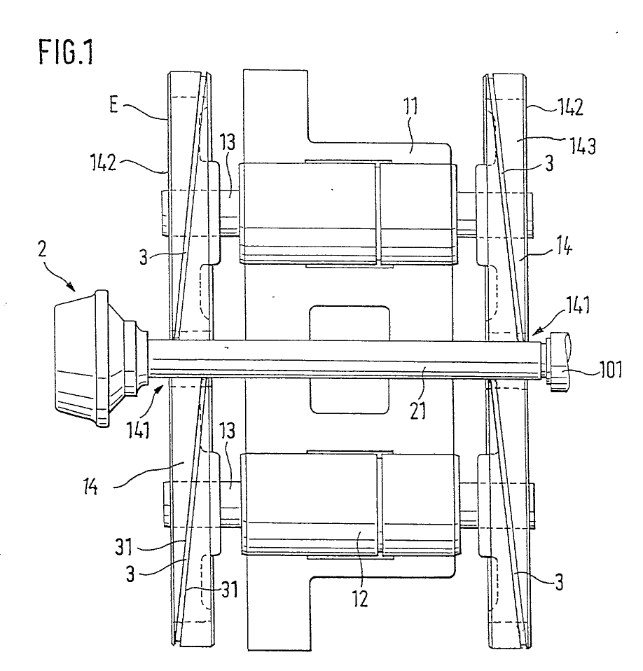

FIG. 1 a presentation of the principles of a bearing system for an open-end spin rotor,

FIG. 2 a cross-section through a support disk of the bearing system of FIG. 1,

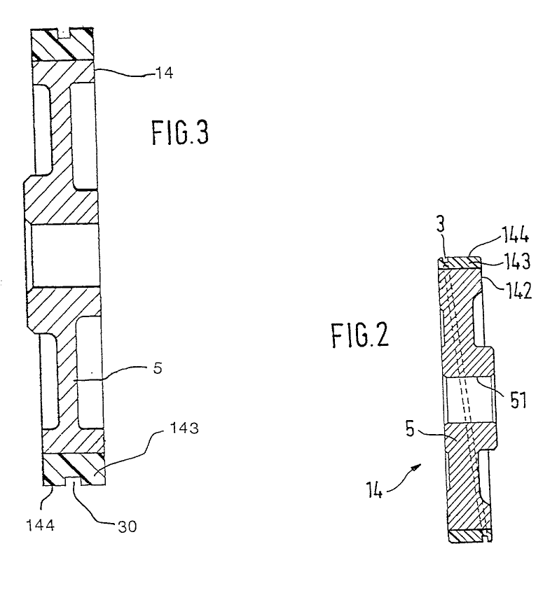

FIG. 3 a cross-section through a support disk with a flat circumferential surface, and

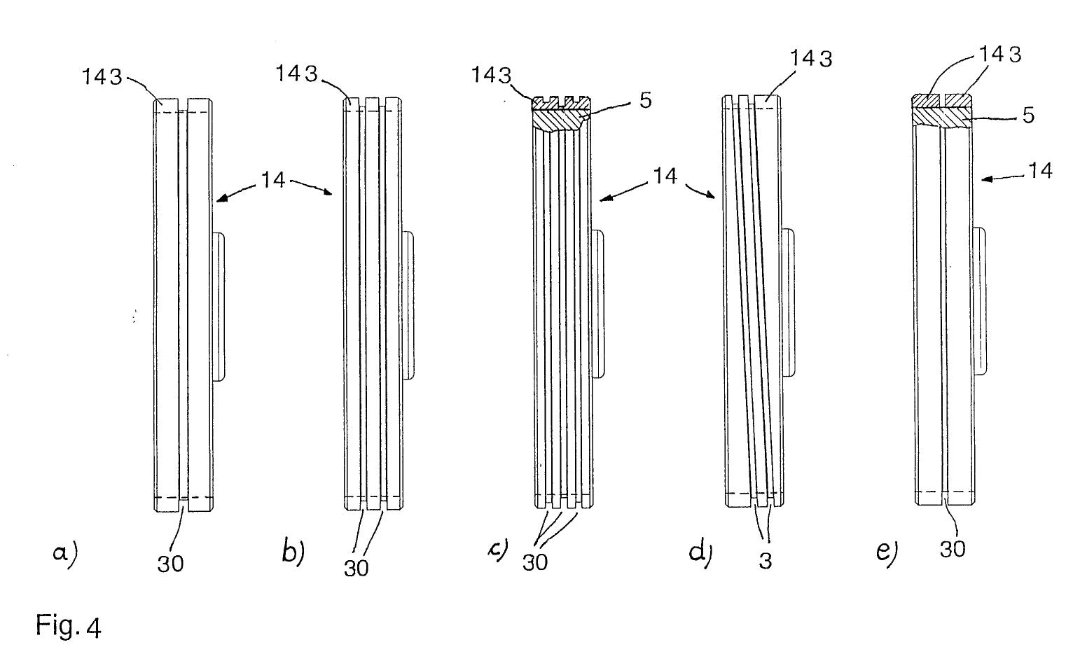

FIG. 4 various embodiments of a support disk in accord with the invention.

FIG. 1 shows the principles of a bearing system 1 for an open-end spin rotor 2, as this is standard where such open-end equipment is installed. The bearing system is comprised, essentially, of a bearing block 11 which carries the support disk bearings 12. The support disk bearings 12, each carry one shaft 13, which, on each of their ends, a support disk 14 is connected by press fit. Together, the support disks 14 form a disk pair, so that between them a wedge shaped opening 141 is formed. The support disks carry the rotor shaft 21 of the open end spin rotor 2. If, the open-end spin rotor 2, for instance, is driven by a tangential belt (not shown), it rolls in the said wedge shaped opening 141 on the support disks 14. Thereby, these are set into rotary motion. The support disks 14 are provided with a cleaning groove 3, which groove, upon the rotation of the support disks 14 wanders with its edges 31 along the contact line of the rotor shaft. The cleaning groove 3 is installed in the cover layer 143 in the form of an endless groove.

Since the run of the rotor shaft connected to the support disks is not entirely slip-free, it is assured that the groove edge 31 reaches every position of the rotor shaft and keeps this shaft free from contaminating deposits.

The shafts 13, which serve as bearing for the support disks 14 are set in their own bearings not parallel to one another, but slightly inclined, so that an axial thrust will be exercised on the rotor shaft 21 by the support disks 14. These support themselves on the axial bearing 101 in a known manner. This bearing can, for example, be designed as a thrust bearing as indicated in FIG. 1, in the form of an aerostatic axial bearing.

By means of the positioning of the rotor shaft 21 in the wedge shaped opening 141 of the support disks 14, there results a relatively high pressure on the rotor shaft against the cover layer 143 of the support disks 14. This pressure is produced since the tangential belts running over the rotor shaft 21 are, on their own account, pressed with a radial force on the rotor shaft 21. This direct pressure is necessary in order to hold the slippage between the tangential belts and the rotor shaft 21 as low as possible. This would permit the rotor shaft 21 and along with it, the open-end spin rotor 2 to be driven without loss. This pressure must be absorbed by the circumferential cover layer 143 of each support disk 14. Because of the fact that the support disks rotate with the rotor shaft 21, then, on the cover layer 143, an alternating pressure force is exercised, which stresses the cover layer 143. The stressing due to this alternating pressure leads to a heating of said cover layer 143 and therewith a thermal load is added.

Besides this type of stress to which the cover layer 143 is subjected, a continual frictional contact of the rotor shaft 21, perpendicular to the plane of the support disk 14 is exerted against the said cover layer 143. This has its origin, as already mentioned above, in the parallel arrangement of the two shafts 13 to each other. This frictional contact by means of the rotor shaft, leads to a stressing of the surface of the support disk in a mechanical way and again leads to a heating of the cover layer 143 produced by this situation.

The support disk 14 shown in FIG. 2 in cross-section, possesses a cleaning groove 3 in the cover layer 143. This forms on its circumference the running surface 144 on which the rotor shaft 21 rolls. The support disk 14 comprises a body 5, which, for example, can be of aluminum, whereupon it could be made by precision molding, or, the support disk 14 can also be of plastic. The support disk 14 possesses in its center a boring 51, by means of which it is fastened to the shaft 13 of a support disk bearing 12 by means of a press fit (see FIG. 1). In the area of the transition of the body 5 to the cover layer 143, the outer circumference of the body 5 is shaped (not shown) in a special manner, for instance it may be V-shaped or hammer shaped.

This shaping leads to an improved adherence between the body and the cover layer 143 so that a better holding power between the body 5 and the cover layer 143 can be assured.

In a more favored construction, the body 5 is so designed, that in the area of a groove in the cover layer 143, a sufficient depth of said cover layer is available to accommodate a cleaning groove.

The assured secure fastening of the cover layer 143 on the body 5 of the support disk, is carried out not only by means of a form fit connection between the body 5 of the disk 14 and the cover layer 143, as is shown in FIG. 2, but also by inherent bonding between the cover layer 143 and the body 5. This bonding, in the case of a support disk constructed in accord with the invention, is essentially greater than is to be found where support disks of the state of the technology are concerned, in which the cover layer 143 is made of polyurethane. The invented cover layer of rubber, has inherently a substantially higher holding power on the body than do cover layers conventionally used in the state of the technology. Furthermore, the invented support disk cover layer of rubber has a lesser tendency to form shrinkage cavities, whereby its adhesiveness is once more increased.

Because of the advantageous, lesser inclination of the cover layer of rubber, particularly of NBR or HNBR to form shrinkage cavities or piping, it becomes possible to apply this material in a thinner layer on the outer circumference of the support disk body.

The support disk 14 depicted in FIG. 3, which again is a cross-section view, possesses a body 5, which has a smooth, cylindrical shaped surface as its circumference, upon which the rubber cover layer 143 is placed in accord with the invention. Because of the particular physical properties of this rubber, in particular, its favorable tenacity to the body material, which, if necessary can be increased by bonding means and/or roughening the contact surface, it is possible, without the body 5 being profiled on the circumference, to make a secure bonding between the cover layer 143 and the body 5. The cover layer 143 shown in FIG. 3 possesses a groove 30, running centrally around the circumference. This groove 30 has the task of a cooling groove for the cooling of the cover layer 143. Such grooves 30 applied for cooling, are common in the state of the technology.

The thickness of the cover layer 143, as it is shown in FIG. 3, allows further design possibilities. In accord with the respective application of various installed rubber cover layers, it is possible to construct the cover layers substantially thinner than the state of the technology requires where polyurethane cover layers are concerned. By the thinner designed cover layer, the advantage is gained, that the cover layer 143 contains a lesser mass, whereby, in turn, its bonding to the body surface experiences an essentially lesser stress from centrifugal action than does the cover layer of the state of the technology. In spite of its being thinner, in the case of the invented rubber cover layer 143 the required characteristics for the damping of the rotor shaft during rolling action remain. Also by the diminishing of the thickness, simultaneously, the heat caused by the compression and release of the substance is closer to the body 5, so that heat dissipation, especially when the support disk bodies are of metal, is essentially improved. This increases the operational life expectancy of the cover layer 143 and therewith also that of the support disk 14.

The favorable characteristics of the support disk cover layer 143 make possible a further design of said layer, especially of the running surface 144, since the cover layer 143 in accord with the invention is more resistant, that is, has a greater capability to minimize erosive damage.

Thus, narrower support disks can be installed, whereby, advantageously, the bearing assembly can be built smaller and will have a lesser mass. Also an advantageous reduction in size of the diameters of the support disks, as a result of the invented materials for the running surface, is now possible.

In FIG. 4, respectively, various embodiments of a support disk in accord with the invention are presented as below:

| | |
|---|---|
| 4a | this embodiment shows a groove 30 in a cover |
| | layer 143 which nearly penetrates through to the |
| | base (dotted line). By the cohesion of the cover |
| | layer at its inner circumferential surface, a very |
| | stable embodimet is created, since the two part |
| | cover layer extending outwardly at its fastening |
| | point is supported on both sides. |
| 4b | In Fig.4b is presented a support disk 14, which has |
| | two circumferential grooves 30. By this means, |
| | three support surfaces are created by the cover |
| | layer for the rotor shaft. |
| 4c | depicts an arrangement of three grooves 30 in the |
| | support disk cover layer 143. As this cross- |
| | section shows, the outer two grooves are formed |
| | less deep in the thickness of the cover layer than |
| | is the center, third groove. The center groove 30 |
| | is, in this case, similar to 4a, as it is formed to a |
| | depth in the cover layer 143 approaching the body |
| | surface 5. |
| 4d | Cleaning grooves 3 appear in this version, which |
| | in the cover layer 143, are slanted, in reference to |
| | the central axis of the body 5. By this device, an |
| | axial thrust is generated on any contaminating |
| | deposit on the rotor shaft 21, whereby such |
| | contamination is gradually abraded and the rotor |
| | shaft 21 in this area is kept nearly free of any |
| | deposits of unwanted material. |
| 4e | This arrangement shows, in support disk 14, two |
| | individual cover layers 143. Each of these cover |
| | layers 143 is made fast, without contact with the |
| | other, on the circumference of the body 5 of the |
| | rotor support disk 14. Because of the |
| | characteristics of the material of the cover layer |
| | 14, a good adherence is secured in this design, in |
| | which no contact with the body 5 of the support |
| | disk 14 is present, or possibly only a very small, |
| | lateral retention will suffice. |

A support disk bearing system is, in general, less sensitive to manufacturing and mounting tolerances than usual, and thereby makes possible a more favorable manufacturing cost. Thus, the possibility becomes evident, that it is not necessary to subsequently spray onto the support disk covering 143 any means of diminishing a lateral stress of said covering. For a precise work-up, principally, only the circumferential surface need be treated by chemical or mechanical profiling.

Further advantages arise from the advantageous material characteristics. Thus, naturally, rubber has inherently a very small electrical conductivity in comparison to the cover layer of the support disk of the support as compared to that of support disks of the state of the technology.

Claimed is:

1. A support disk for a support disk bearing of an open end spin rotor (2), which possesses a body (5) with a connection for a shaft (13) for holding the support disk (14) and a circumferential surface for the reception of a plastic cover layer (143) to act as bearing means for an open end spin rotor (2), therein characterized, in that the cover layer (143) is made of rubber.

2. A support disk in accord with claim 1, therein characterized, in that the cover layer (143) is made of nitrile rubber (NBR).

3. A support disk in accord with claims 1 and 2, therein characterized, in that the cover layer essentially is composed of rubber H-NBR.

4. A support disk in accord with one or more of the claims 1 to 3, therein characterized, in that the cover layer is composed of rubber with a tensile strength of at least 28 N/mm^{2.}

5. A support disk in accord with one or more of the claims 1 to 4, therein characterized, in that the cover layer (143) is composed of a rubber with a hardness between Shore A 85 and 105.

6. A support disk in accord with one or more of the claims 1 to 5, therein characterized, in that the rubber possesses a hardness between 45 and 70 Shore D.

7. A support disk in accord with one or more of the claims 1 to 6, therein characterized, in that the rubber possesses an elasticity of at least 29%.

8. A support disk in accord with one or more of the claims 1 to 7, therein characterized, in that the support disk (14) has, on the circumferential surface of the cover layer, one or more grooves (3, 30).

9. A support disk in accord with one or more of the claims 1 to 8, therein characterized, in that the groove(s) (3, 30) penetrate to the body (5).

10. A support disk in accord with one or more of the claims 1 to 9, therein characterized, in that the support disk (14) possesses at least one groove (30) for the cooling of the cover layer (143) on the circumferential surface of the said cover layer (143).

11. A support disk in accord with one or more of the claims 1 to 10, therein characterized, in that the cover layer (143) has a thickness of less then 4 mm or less than 1.9 times the deepest groove (3, 30).

12. A support disk in accord with one or more of the claims 1 to 11, therein characterized, in that the covering layer of the support disk (14) possesses on its circumference at least one, preferably two cleaning grooves (3).

13. A support disk in accord with one or more of the claims 1 to 12, therein characterized, in that the electrical resistance of the covering layer (143) has a value of less than 1×10⁹ Ohm.

14. A support disk in accord with one or more of the claims 1 to 13, therein characterized, in that the cover layer (143) contains an additive for the reduction of the electrical resistance to below 1×10⁹ Ohm.

15. A support disk in accord with one or more of the claims 1 to 14, therein characterized, in that the body (5), especially after the application of the covering layer (143) is surface treated, i.e. is anodized.

16. A support disk in accord with one or more of the claims 1 to 15, therein characterized, in that the support disk (14) has an outer diameter between 50 and 80 mm.

17. A support disk in accord with one or more of the claims 1 to 16, therein characterized, in that the contact surface between the cover layer (143) and the rotor shaft (21) exhibits a width between 4 and 12 mm.

18. A support disk in accord with one or more of the claims 1 to 17, therein characterized, in that the minimum width of the cover layer (143) is 2 mm.
